(19) United States
(12) Patent Application Publication
(10) Pub. No.: US 2012/0026034 A1
(43) Pub. Date: Feb. 2, 2012

(54) POSITION CALCULATION METHOD AND APPARATUS WITH GPS

(75) Inventor: Kazuyuki Shiomi, Wako-shi (JP)

(73) Assignee: HONDA MOTOR CO., LTD., Tokyo (JP)

(21) Appl. No.: 13/195,460

(22) Filed: Aug. 1, 2011

(30) Foreign Application Priority Data
Aug. 2, 2010 (JP) 2010-173782
Aug. 24, 2010 (JP) 2010-187562

(51) Int. Cl. G01S 19/42

(52) U.S. Cl. 342/357.25

(57) ABSTRACT

A GPS position calculating apparatus is configured to acquire from navigation data contained in signals transmitted from GPS satellites, orbit information including a position, clock time, orbital speed and altitude of each GPS satellite at a transmission time of each signal from a respective one of the GPS satellites, then calculate a position of each GPS satellite at a reception time of the same signal at a measurement point on the basis of the acquired orbital speed and a time difference between the reception time and the transmission time, further calculate a first angle of the horizon relative to a first line segment connecting the second position of each GPS satellite with a position of the measurement point on the basis of a range of the first line segment and the acquired altitude, subsequently calculate a range of a second line segment connecting the first position of each GPS satellite with the position of the measurement point on the basis of the range of the first line segment, the first angle, and the orbital speed, and finally perform calculation of the position of the measurement point. A GPS position calculating method carried out by the apparatus is also disclosed.

### FIELD OF THE INVENTION

The present invention relates to a method of and an apparatus for calculating the position of a measurement point on the earth or the positions of plural GPS (global positioning system) satellites by using signals received from the GPS satellites.

### BACKGROUND OF THE INVENTION

In order to perform detection of an actual position of a GPS receiver, the GPS receiver needs to learn the distances to GPS satellites and positions of the GPS satellites. Signals transmitted from the GPS satellites are modulated and contain data called “navigation message”, which includes orbit information. The navigation message will be hereinafter referred to as “navigation data”.

The GPS receiver receives navigation data from the GPS satellites and by measuring positions of the GPS satellites and the distances from the GPS satellites to a measurement point, the GPS receiver detects a position of the measurement point, which is constituted by a movable object, such as an automobile, marine vessel, aircraft, working vehicle, or mobile terminal.

The GPS receiver involves a time difference Δt between a transmission time at which a signal is transmitted from each GPS satellite, and a reception time at which the same signal is received at the GPS receiver. In this instance, if an internal clock of the GPS receiver and atomic clocks in the GPS satellites are in perfect synchronization with each other, the GPS receiver receives navigation data with a delay corresponding to a transit time of radio wave. The GPS receiver is, therefore, able to determine the distance to the GPS satellite by multiplying the transit time of radio wave with the speed of light (propagation velocity of electromagnetic field).

However, the GPS receiver clock often goes out of synchronization with the GPS satellites clocks. Thus, the GPS receiver determines the distance to each GPS satellite as a “pseudorange”, which involves clock error. Here, the pseudorange is the distance from the GPS receiver to each GPS satellite and is measured as the sum of a correct distance and a clock error caused by a gain of the GPS receiver clock. Thus, the GPS receiver determines the pseudorange by multiplying a signal transit time by the speed of light, where the signal transit time is obtained by subtracting the signal transmission time at each GPS satellite from the signal reception time at the GPS receiver. The thus calculated pseudoranges and positions of the GPS satellites at the signal transmission time that can be obtained by receiving ephemeris parameters of the navigation data, the position of the measurement point in a three dimensional space can be calculated. A typical example of such GPS position calculation method is disclosed in International Patent Application Publication No. WO 2005/017552 (corresponding to US 2006/0116820 A1).

The ephemeris parameters of the navigation data used in the GPS are, as shown here in FIG. 8, determined based on observation data obtained by monitoring stations (GPS receivers 105 to 109) located on the earth as five reference points with positional data already known. Since the position of a measurement point is calculated from the position of the GPS satellite 101, the position of the GPS satellite is very important and hence is updated about every two hours. The GPS receiver located on a measurement point calculates the current position the GPS satellite on a three-dimensional basis from the position of the GPS satellite 101 at the signal transmission time and the pseudorange.

In the case where the aforesaid clock error Δt is small, the GPS receiver should be able to calculate the position of a measurement point by using three variables x, y and z acquired from signals from the GPS satellites. However, because the clock error Δt is significantly large, a technique has been proposed in which the clock error Δt is used as a fourth variable additional to the three variables x, y, z, in order to detect the current position of the measurement point. For example, as shown here in FIG. 9, the GPS receiver 105 needs to receive navigation data from at least four GPS satellites 101-104.

According to another known GPS position calculation method, such as shown in Japanese Patent No. 3524018 (corresponding to JP 2001-4733 A), navigation data from more than four GPS satellites are used. All of the known techniques specified above have a limited positioning accuracy due to a large error involved in the calculated pseudorange. In view of this, various methods have been proposed in order to improve the positioning accuracy. One example of such proposed methods is shown in FIG. 10, where differential data obtained as the results of positioning at a reference base station (stationary station receiver) 110 on the earth are used to estimate errors involved in the pseudoranges. The proposed methods still have drawbacks that the entire system is rendered complicated and the calculation time and cost increase.

It may be considered that a clock error and an orbit error of each GPS satellite, an ionosphere delay and a troposphere delay during signal propagation, a change in the antenna phase center, a clock error and a multipath cancellation of the GPS receiver cause errors. The clock errors include an error caused by the clock itself, and a time delay caused by a so-called “relativistic effect” according to the theory of specific relativity or general relativity. Furthermore, random noise may be considered as an error-inducing factor.

To limit the error effects, various attempts have been made, but no decisive measures have so far been found and a process of trial and error is still continued. Under these circumstances, a certain method has been employed wherein pseudoranges are estimated either from data acquired from more than four GPS satellites, or from the results of positioning at a reference base station on the earth. Furthermore, as evidenced by a graph shown here in FIG. 11, the positioning error has an elevation-angle-dependent property. In view of this elevation-angle-dependent property, it is a general way to preferentially use data from a GPS satellite of large elevation angle where the positioning error is relatively small. However, due to the positioning error, the pseudorange calculation method and system are rendered complicated.

### SUMMARY OF THE INVENTION

It is accordingly an object of the present invention to provide GPS position calculating method and apparatus, which are able to calculate pseudoranges in a simple and accurate manner, thereby improving the detection accuracy of the position of a measurement point or the position of a GPS satellite at a signal transmission time.

According to a first aspect of the present invention, there is provided a position calculating method using a global positioning system (GPS) for determining the position of a measurement point on the horizon by a computing unit on the basis of signals received at a receiver on the measurement point from at least three GPS satellites, the method comprising: a first step of acquiring orbit information from navigation data contained in the signals received at the receiver, said orbit information including a first position, clock time, orbital speed and altitude of each of the GPS satellites at a time when each GPS satellite transmits a respective one of the signal; a second step of calculating a second position of each GPS satellite at a time when the signal from each GPS satellite is received at the receiver, by using the acquired orbital speed and a time difference obtained by subtracting the signal transmission time from the signal reception time, and further calculating a first angle of the horizon relative to a first line segment connecting the second position of each GPS satellite with a position of the measurement point on the basis of a range of the first line segment and the acquired altitude; a third step of calculating a range of a second line segment connecting the first position of each GPS satellite with the position of the measurement point on the basis of the range of the first line segment, the first angle, and the orbital speed; and a fourth step of calculating the position of the measurement point from the respective ranges of the second line segments each connecting a respective one of the first positions of the at least three GPS satellites with the position of the measurement point.

With the position calculating method thus arranged, the second step calculates a second position of each GPS satellite at the signal reception time from the orbital speed and the signal transmission time acquired from the signals received at the receiver, and further calculates a first angle of the horizon relative to a first line segment connecting the second position of the GPS satellite with a position of the measurement point on the basis of a range of the first line segment and the acquired altitude. On the basis of the range of the first line segment, the first angle calculated by the second step, and the orbital speed, the third step calculates a range of a second line segment connecting the first position A of each GPS satellite with the position of the measurement point as a pseudorange.

Thus, the calculation of the pseudorange additionally requires information about the orbital speed and the first angle. However, merely by replacing the distance or range from the measurement point to the GPS satellite at the signal reception time, which is conventionally used as a pseudorange, with the range from the measurement point to the GPS satellite at the signal transmission time, which is the original pseudorange, the pseudorange calculation can be achieved with high accuracy.

The fourth step calculates the position of the measurement point on the basis of information about the respective positions of the at least three GPS satellites at the signal transmission time and the calculated pseudoranges. With this calculating step, it is possible to improve the position detecting accuracy at the measurement point and to reduce the number of GPS satellites needed for position calculation. The position calculating method of the present invention does not need reference positioning data supplied from a base station on the earth and hence is able to simplify the calculation method or procedure.

Preferably, the second step further calculates a second angle of the horizon relative to the second line segment connecting the first position of each GPS satellite with the position of the measurement point on the basis of the calculated first angle and the acquired orbital speed of each GPS satellite. The second step further requires data about the second angle additional to the data about the first angle data. However, merely by replacing the conventional pseudorange with the original pseudorange, the pseudorange calculation accuracy is further improved.

It is preferred that the second step achieves calculation of the first angle or the second angle by solving the following equation (1):

$${sin}^{2} α = \{ {( cos \partial - \frac{v}{c} )}^{2} + {sin}^{2} α \} {sin}^{2} β \qquad ( 1 )$$

where α is the first angle, β is the second angle, v is the acquired orbital speed of each GPS satellite, and c is the speed of light. By thus defining the relationship between the first angle and the second angle using the equation (1), the pseudorange calculation is independent from the size of a zenith angle (elevation angle) and hence is able to achieve a higher degree of calculation accuracy.

Preferably, the third step achieves calculation of the range of the second line segment by solving the following equation (2):

$$cs = \sqrt{{( cos α - \frac{v}{c} )}^{2} + {sin}^{2} α} \times ct \qquad ( 2 )$$

where cs is the range of the second line segment, α is the first angle, v is the orbital speed of each GPS satellite, c is the speed of light, and ct is the range of the first line segment. In order to solve the equation (2), information about the orbital speed and the first angle are needed. However, by using the range from the measurement point to the GPS satellite at the signal transmission time as a pseudorange in place of the conventionally used pseudorange from the measurement position to the GPS satellite at the signal reception time, the pseudorange calculation can be achieved with high accuracy.

It is preferred that third step achieves calculation of the range of the second line segment by further calculating speeds of movement of the measurement point and each GPS satellite in rotational inertial coordinate systems at a point of time using the following expressions (3) and (4):

$$vrt = 2 r sin \frac{ω t}{2} \qquad ( 3 )$$

where vrt is the speed of movement of the measurement point on the earth at a point of time t, ω is the relative angular velocity between the measurement point and each GPS satellite, and r is the radius of the earth.

$$vRt = 2 R sin \frac{ω t}{2 } \qquad ( 4 )$$

where vRt is the speed of movement of each GPS satellite at t, ω is the relative angular velocity between the measurement point and each GPS satellite, and R is the radius of the orbit of each GPS satellite. With this arrangement, it is possible to calculate a pseudorange with high accuracy without involving any error even when the GPS satellites are moving in elliptic or more complicated orbits.

Preferably, the fourth step achieves calculation of the position of the measurement point by solving the following equation (5):

$$\{ \begin{matrix}cs 1 = \sqrt{{( x 1 - x )}^{2} + {( y 1 - y )}^{2} + {( z 1 - z )}^{2}} \\ c s 2 = \sqrt{{( x 2 - x )}^{2} + {( y 2 - y )}^{2} + {( z 2 - z )}^{2}} \\ c s 3 = \sqrt{{( x 3 - x )}^{2} + {( y 3 - y )}^{2} + {( z 3 - z )}^{2}}\end{matrix} \qquad ( 5 )$$

where cs1 is the range of the second line segment connecting the first position of the first GPS satellite with the position of the measurement point, cs2 is the range of the second line segment connecting the first position of the second GPS satellite with the position of the measurement point, cs3 is the range of the second line segment connecting the first position of the third GPS satellite with the position of the measurement point, (x,y,z) is the position coordinate of the receiver, (x1,y1,z1) is the position coordinate of the first GPS satellite, (x2,y2,z2) is the position coordinate of the second GPS satellite, and (x3,y3,z3) is the position coordinate of the third GPS satellite. By thus calculating the position of the measurement point on the basis of the respective positions of the at least three GPS satellites at the signal transmission time and the calculated pseudoranges, the position detecting accuracy can be improved. Furthermore, the pseudorange calculation method or procedure is relatively simple because it does not require the use of many GPS satellites and can eliminate the use of reference positioning data from a base station on the earth.

According to a second aspect of the present invention, there is provided a position calculating apparatus using a global positioning system (GPS) for determining the position of a measurement point on the horizon by a position calculating unit on the basis of signals received at a receiver on the measurement point from at least three GPS satellites, the apparatus comprising: a navigation data acquiring section for acquiring orbit information from navigation data contained in the signals received at the receiver, said orbit information including a first position, clock time, orbital speed and altitude of each of the GPS satellites at a time when each GPS satellite transmits a respective one of the signals; an elevation angle calculating section for calculating a second position of each respective GPS satellite at a time when the signal from each respective GPS satellite is received at the receiver, by using the acquired orbital speed and a time difference obtained by subtracting the signal transmission time from the signal reception time, and further calculating a first angle of the horizon relative to a first line segment connecting the second position of each GPS satellite with a position of the measurement point on the basis of a range of the first line segment and the acquired altitude; a pseudorange calculating section for calculating a range of a second line segment connecting the first position of each GPS satellite with the position of the measurement point on the basis of the calculated range of the first line segment, the first angle, and the orbital speed; and a position calculating section for calculating the position of the measurement point from the respective ranges of the second line segments each connecting a respective one of the first positions of the at least three GPS satellites with the position of the measurement point.

With the position calculating apparatus thus arranged, the elevation angle calculating section calculates a second position of each GPS satellite at a time when the signal from each GPS satellite is received at the receiver, by using the acquired orbital speed and a time difference obtained by subtracting the signal transmission time from the signal reception time, and further calculating a first angle of the horizon relative to a first line segment connecting the second position of each GPS satellite with a position of the measurement point on the basis of a range of the first line segment and the acquired altitude. The pseudorange calculating section calculates a range of a second line segment connecting the first position of each GPS satellite with the position of the measurement point on the basis of the calculated range of the first line segment, the first angle, and the orbital speed. This arrangement makes it possible to reduce the number of GPS satellites needed for position calculation, eliminate the use of reference positioning data supplied from a base station on the earth, and simplify the computing method or procedure. Calculation of the pseudorange requires information about the first and second angles, however, merely by replacing the conventional pseudorange at the signal reception time with the pseudorange at the signal transmission time, the pseudorange calculation can be achieved with improved accuracy. The position calculating section calculates the position of the measurement point on the basis of information about the respective positions of the GPS satellites at the signal transmission time and the calculated pseudoranges. This arrangement makes it possible to increase the position detecting accuracy at the measurement point.

According to a third aspect of the present invention, there is provided a GPS (global positioning system) satellite position calculating method wherein signals transmitted from at least three GPS satellites are received by a receiver at a reference point on the horizon, and the position of each respective GPS satellite at a transmission time when each GPS satellite transmits a respective one of the signals is calculated by a computing unit on the basis of a known position of the reference point, the method comprising: a first step of acquiring orbit information from the signals received at the receiver from the GPS satellites, the orbit information including a transmission time of each of the signals, orbital speed and altitude of each GPS satellite; a second step of calculating a position of each of the GPS satellites at a reception time when the signal from each GPS satellite is received at the receiver, from the acquired orbital speed and a time difference between the reception time and the transmission time, and further calculating an angle which a line segment connecting the position of the GPS satellite at the reception time with the position of the reference point forms with respect to the horizon; a third step of calculating a distance from the position of the reference point to the position of each GPS satellite at the transmission time on the basis of a distance from the position of the reference point to the position of each respective GPS satellite at the reception time, the acquired altitude, and the angle; and a fourth step of calculating the position of each respective GPS satellite at the transmission time from the calculated distance from the position of the reference point to the position of each of the at least three GPS satellite at the transmission time.

According to a fourth aspect of the present invention, there is provided a GPS (global positioning system) satellite position calculating apparatus including a receiver for receiving signals transmitted from at least three GPS satellites, and a computing unit for calculating the position of each of the GPS satellites at a transmission time when each GPS satellite transmits a respective signal on the basis of a reference position having a known position on the horizon, the apparatus comprising: a navigation information acquiring section for acquiring orbit information from the signals received at the receiver from the GPS satellites, the orbit information including a transmission time of each respective signal, orbital speed and altitude of each GPS satellite; an elevation angle calculating section for calculating a position of each respective GPS satellite at a reception time when the signal from each GPS satellite is received at the receiver, by using the acquired orbital speed and a time difference between the reception time and the transmission time, and further calculating an angle which a line segment connecting the position of the GPS satellite at the reception time with the position of the reference point forms with respect to the horizon; a pseudorange calculating section for calculating a distance from the position of the reference point to the position of each GPS satellite at the transmission time on the basis of a distance from the position of the reference point to the position of each respective GPS satellite at the reception time, the acquired altitude, and the angle; and a satellite position calculating section for calculating the position of each respective GPS satellite at the transmission time from the calculated distance from the position of the reference point to the position of each of the at least three GPS satellite at the transmission time.

According to the GPS satellite position calculating method and apparatus just described above, the distance between the position of each GPS satellite at the signal transmission time and the known position of the reference point is used as a pseudorange in the process of calculating the position of the GPS satellite. Unlike the conventional arrangement in which the distance between the position of each GPS satellite at the signal reception time and the known position of the reference point is used as a pseudorange in the process of calculating the position of the GPS satellite, the aforesaid arrangement of the present invention is able to simplify the calculation method or procedure, increase the calculation accuracy, and eventually improve the accuracy in detecting the position of GPS satellite. Furthermore, calculation of the GPS position at the transmission time does not require observation data to be supplied from a known receiver site on the earth and this arrangement adds to the degree of simplification of the calculation method of procedure.

### BRIEF DESCRIPTION OF THE DRAWINGS

Certain preferred embodiments of the present invention will hereinafter be described in detail, by way of example only, with reference to the accompanying drawings, in which:

FIG. 1 is a block diagram showing a general configuration of a GPS position calculating apparatus embodying the present invention;

FIGS. 2A through 2E are vector diagrams showing the basic concept of a GPS position calculating method of the present invention by using two inertial coordinate systems;

FIG. 3 is a vector diagram showing the relationship between angles of a GPS satellite and a measurement point in the inertial coordinate systems shown in FIGS. 2A through 2E;

FIG. 4 is a flowchart showing a sequence of operations of the GPS position calculating apparatus;

FIGS. 5A and 5B are vector diagrams showing the basic concept of the GPS position calculating method of the invention by using rotational inertial coordinate systems;

FIG. 6 is a flowchart showing a sequence of operations of the GPS position calculating apparatus when the apparatus is used as a GPS satellite position calculating apparatus according to another embodiment of the present invention;

FIG. 7 is a flowchart showing a sequence of operations of the GPS position calculating apparatus when the apparatus is used as a GPS satellite position calculating apparatus according to still another embodiment of the present invention;

FIG. 8 is a diagrammatical view showing a conventional GPS satellite position calculating method;

FIG. 9 is a diagrammatical view showing a conventional GPS position calculating method;

FIG. 10 a diagrammatical view showing a conventional GPS position calculating method using differential data; and

FIG. 11 is a graph showing the relationship between the satellite elevation angle and the positioning error involved in the GPS position calculation.

### DETAILED DESCRIPTION OF THE PREFERRED EMBODIMENTS

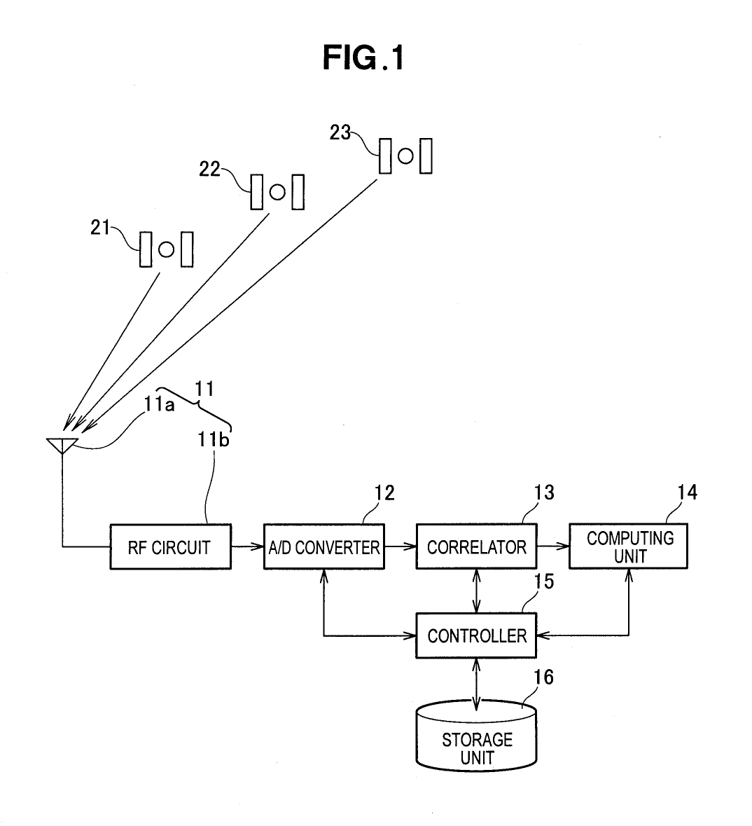

A first embodiment of the present invention will be described with reference to the accompanying sheets of drawings. Referring first to FIG. 1, there is shown in block diagram a GPS position calculating apparatus 10 according to the first embodiment of the present invention. The GPS position calculating apparatus 10 generally comprises a receiver 11, an analog-to-digital converter (A/D converter) 12, a correlator 13, a computing unit 14, a controller 15, and a storage unit 16. The receiver 11 includes an antenna 11a and a high-frequency circuit 11b. The high-frequency circuit 11b will be hereinafter referred to as “radio frequency (RF) circuit”.

The RF circuit 11b receives via the antenna 11a signals (radio waves) transmitted from at least three GPS satellites 21, 22 and 23 and down-converts the received GPS satellite signals into signals of intermediate frequency (IF) band. The IF band signals are then output from the RF circuit 11b to the A/D converter 12.

The A/D converter 12 converts the analog signals output from the RF circuit 11b into digital signals and outputs the thus converted digital signals to the correlator 13 and the controller 15.

The correlator 13 detects a reception frequency on the basis of the input digital signals. More particularly, the correlator 13 demodulates the digital signals output from the A/D converter 12 from coarse and acquisition (C/A) codes of the GPS satellites and computes radio wave transit lags or delays.

The controller 15 has a function to acquire navigation data from the digital signals output from the A/D converter 12 and output the acquired navigation data to the computing unit 14, and also has a function to issue a position calculation order or command to the computing unit 14, instructing the computing unit 14 to perform pseudorange calculations and position calculations. The navigation data used for the GPS position calculations includes almanac data and ephemeris data.

The almanac data contains parameters indicative of coarse positions of all GPS satellites. The almanac date is available for about two weeks. This time limit is provided in view of a time-dependent orbital shift of each GPS satellite and corresponds to an available period of the almanac data. The ephemeris data contains parameters providing the precise orbit information for each GPS satellite and is used when the controller 15 executes position calculation for each GPS satellite. The ephemeris data is available for about two hours.

The computing unit 14 achieves a series of operations under program control by the controller 15, wherein the operations starts at a first step and ends at a forth step, as will be discussed below.

At the first step of operation, the computing unit 14 acquires orbit information of the GPS satellites 21, 22, 23 from navigation data contained in the signals received by the RF circuit 11b. The orbit information includes a position A1, A2, A3 (collectively designated as “A”), clock time tb1, tb2, b3 (collectively designated as “tb”), orbital speed v1, v2, v3 (collectively designated as “v”), and altitude h1, h2, h3 (collectively designated as “h”) of each of the GPS satellites 21, 22, 23 at a transmission time when each GPS satellite 21, 22, 23 transmits a respective signal.

At a second step of operation, the computing unit 14 calculates a position B1, B2, B3 (collectively designated as “B”) of each respective GPS satellite 21, 22, 23 at a reception time “tr” when the signal from each GPS satellite is received at the receiver 11 of the GPS position calculating apparatus 10 located at a measurement point, by using the acquired orbital speed v and a time difference “t” obtained by subtracting the transmission time tb from the reception time tr as (t=tr−tb). The computing unit 14 further calculates a first angle α1, α2, α3 (collectively designated by “α”) of the horizon relative to a first line segment connecting the position B of each GPS satellite with a position O of the measurement point on the basis of a distance or range ct of the first line segment and the altitude h.

At a third step of operation, the computing unit 14 calculates a distance or range cs1, cs2, cs3 (collectively designated as “cs”) of a second line segment connecting the position A of each GPS satellite 21, 22, 23 with the position O of the measurement point on the basis of the range ct of the first line segment and the first angle α that are calculated at the second step and the orbital speed v acquired at the first step.

At a fourth step of operation, the computing unit 14 calculates the position O of the measurement point from the respective ranges cs (cs1, cs2, cs3) of the second line segments each connecting a respective one of the positions A of the at least three GPS satellites 21, 22, 23 with the position O of the measurement point.

The first to fourth operation steps are programmed in advance and stored in the storage unit 16. The controller 15 is constituted by, for example, a microprocessor, and by sequentially retrieving and executing the program stored in the storage unit 16, the controller 15 urges the computing unit 14 to perform calculation of the angles α and ranges (pseudoranges) cs and calculation of the position O of the measurement point in succession.

The storage unit 16 also stores other pieces of information concerning the center position and radius “r” of the earth, frequencies of the GPS satellites 21, 22, 23, and the speed “c” of light that are referenced by the controller 15.

Operation for calculating the angles α, pseudoranges cs and the position O of the measurement point will be described as being achieved by the computing unit 14 under the control of the control unit 15. However, the control unit 15 may undertake such calculations in place of the computing unit 14.

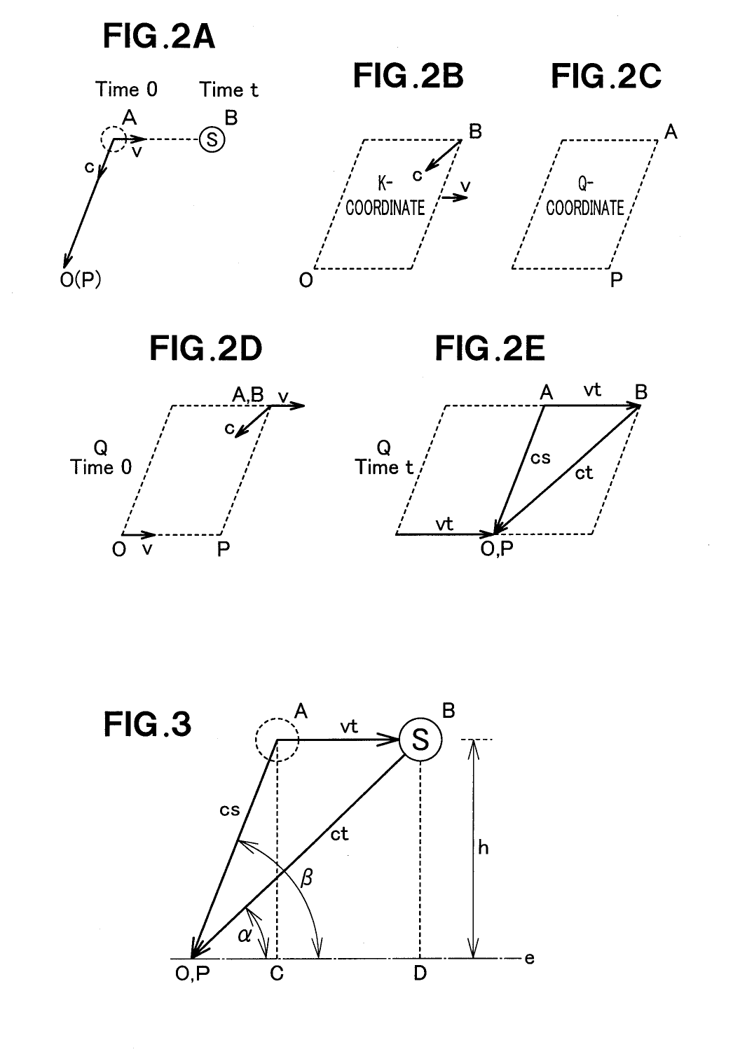

Before starting description about operation of the GPS position calculating apparatus 10, the basic concept of the GPS position calculation will be briefly described with reference to FIGS. 2A to 2E and FIG. 3.

Description will be given on the assumption that as shown in FIG. 2A, at a point of time 0 (Time=0), a signal transmitted from a GPS satellite located at a position A is received by the GPS position calculating apparatus 10 located at a measurement point O. When the GPS position calculation apparatus 10 receives the GPS satellite signal, the GPS satellite has already moved from the position A to a position B. For convenience of explanation, the position A will be hereinafter referred to as “reference position” of the GPS satellite, and the position B as “current position” of the GPS satellite. Reference character S in FIG. 2A denotes the GPS satellite.

The foregoing phenomenon will be described using a K-coordinate (coordinate of the GPS satellite 5) indicated by a dotted-lined quadrangle (parallelogram) shown in FIG. 2B and a Q-coordinate (coordinate on the earth) indicated by a dotted-lined quadrangle (parallelogram) shown in FIG. 2C.

As shown in FIG. 2B, the measurement point O and the position B of the GPS satellite are located diagonally at opposing corners of the K-coordinate. Similarly, as shown in FIG. 2C, the position A of the GPS satellite is located at the right end of a topside of the Q-coordinate. The K-coordinate is moving rightward with a speed v relative to the Q-coordinate. Here, the GPS satellite S is always present at the position B in the K-coordinate. These two inertial coordinate systems (in which the inertial law can apply) overlap each other at the point of time 0 (Time=0), as shown in FIG. 2D.

In FIG. 2D, the reference position A and the current position B overlap each other. In this condition, if the GPS satellite transmits a signal at a point of time (Time=0) with a radio wave propagation speed (the speed of light, “c”) from the position A toward the measurement point O in the K-inertial coordinate system, the signal will reach the measurement point O after a lapse of a predetermined time t (Time=t). The distance or range from the position B to the measurement point O is set to be “ct”, and the distance or range from the measurement point O to a point P is set to be “vt”.

After a lapse of the predetermined time t from the transmission time (Time=0) of the GPS satellite signal, i.e., at the point of time (Time=t), the measurement point O and the point P overlap each other as shown in FIG. 2E. In FIG. 2E, the signal transmitted from the position B by the GPS satellite reaches the measurement point O. In this instance, it appears for the GPS position calculating apparatus 10 located in the Q-inertial coordinate system that the signal transmitted from the position A has reached the point P. Since the signal in the Q-inertial coordinate system also travels with the speed of light, the distance or range from the position A to the point P is given as “cs”.

The relationship between the signal and the motion in the inertial coordinate systems is shown in combination with the angle, such as shown in FIG. 3. In FIG. 3, an elevation angle of the GPS satellite at the transmission time of the signal (i.e., an angle of a line segment connecting the reference position A of the GPS satellite S with the position O of the measurement point relative to the horizon e) is designated by β, and an elevation angle of the GPS satellite S at the reception time of the same signal at the GPS position calculating apparatus 10 (i.e., an angle of a line segment connecting the current position B of the GPS satellite S with the position O of the measurement point relative to the horizon e) is designated by α. The GPS satellite S has an altitude h. The altitude h, orbital speed v and clock time t of the satellite are determined by navigation data transmitted from the GPS satellite.

As shown in FIG. 3, the distance or range cs can be expressed by the following equation (6) using the Pythagorean theorem as applied to a right triangle ΔAOC.

cs=\sqrt{(ct×cos α−vt)²+(ct×sin α)²} (6)

Here, the term ct×sin α is equivalent to an altitude h. By substituting the equation (6) into the following equation: ct·sin α=cs·sin β which is a length relational expression of the two right triangles ΔAOC and ΔOBD, we obtain the following equation (7). Further modifying the equation (7) develops the following equation (8), which is an angle relational expression. Considering the above-identified length relational expression in conjunction with the equation (8), we obtain the following time-variable expression (9).

$$\begin{matrix}ct \times sin α = \sqrt{{( ct \times cos α - vt )}^{2} + {( ct \times sin α )}^{2}} \times sin β & ( 7 ) \\ {sin}^{2} α = \{ {( cos \partial - \frac{v}{c} )}^{2} + {sin}^{2} α \} {sin}^{2} β & ( 8 ) \\ \frac{s}{t} = \sqrt{{( cos α - \frac{v}{c} )}^{2} + {sin}^{2} α} & ( 9 )\end{matrix}$$

According to the angle relational expression (8), the GPS position calculating apparatus 10 located at the measurement point can calculate an angle α of the line segment connecting the current position B of the GPS satellite S with the position O of the measurement point relative to the horizon e and an angle β of the line segment connecting the reference position A of the GPS satellite S with the position O of the measurement point relative to the horizon. Form the angle α calculated using the expression (8), a pseudorange cs from the position O of the measurement point to the GPS satellite S at the reception time of the signal from the GPS satellite S is obtained by the following equation (10).

$$cs = \sqrt{{( cos α - \frac{v}{c} )}^{2} + {sin}^{2} α} \times ct \qquad ( 10 )$$

In the angle relational expression (8), if β=π/2, we obtain α=cos⁻¹(v/c). In this instance, the time-variable expression (9) is modified into the following arithmetic expression (11).

$$\frac{s}{t} = \sqrt{1 - \frac{{v}^{2}}{{c}^{2}}} \qquad ( 11 )$$

The arithmetic expression (11) corresponds to a time-delay according to the theory of special relativity. This means that the relationship between the angle α and the angle β cannot be considered by the theory of special relativity. In view of this, calculation of the pseudorange has conventionally been performed on the basis of such a signal transmitting from a GPS satellite having a large elevation angle because the positioning error tends to increase as the satellite elevation angle becomes small, as shown in FIG. 11. This tendency is similar to that of a zenith angle error, which has been reported heretofore as an error. The zenith angle error increases at a rate of about 1/cos with an increase in the zenith angle.

According to the embodiment of the present invention, the relationship between the angle α and the angle β is reflected on calculation of the pseudorange so that the pseudorange can be calculated with high accuracy without depending on the zenith angle. Furthermore, there is no need to delay the clock in the GPS satellite relative to the clock of the receiver in consideration of the theory of special relativity. The GPS satellite clock and the receiver clock need to be synchronized with each other. The base concept of the pseudorange calculation involving relatively moving two inertial coordinate systems has thus been described.

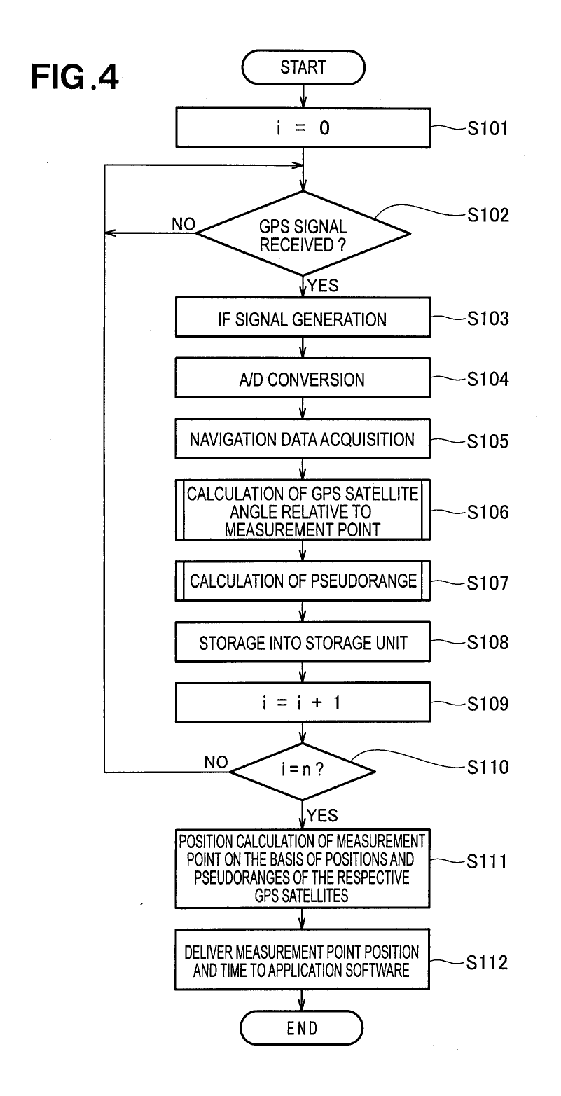

Operation of the GPS position calculating apparatus 10 according to the first embodiment of the present invention shown in FIG. 1 will be described in detail with reference to a flowchart shown in FIG. 4. The flowchart shows a sequence of operations to be executed by the controller 15.

At step S101, the controller 15 sets a count value i of a counter assigned to the program to “0”. The counter counts the number of target GPS satellites from which signals are to be received. In the illustrated embodiment, the number “n” of target GPS satellites is three, and these three target Satellites 21, 22 and 23 are used for determining the position of a measurement point.

At step S102, the controller 15 determines as to whether a high-frequency analog signal transmitted from the first GPS satellite 21 has been received by the RF circuit 11b. If an affirmative determination is made (YES) at step S102, the control process goes on to step S103, where the RF circuits 11b down-converts the high-frequency analog signal into an IF analog signal and outputs the IF analog signal to the A/D converter 12.

Subsequently, the controller 15 issues a signal conversion order to the A/D converter 12, whereupon at step S104, the A/D converter converts the IF analog signal to a digital signal and outputs the digital signal to the correlator 13 and the controller 15. Subsequently, at step S105 the controller 15 acquires navigation data (orbital speed v, transmission time tb, and altitude h) from the digital signal and outputs the acquired navigation data to the computing unit 14. At the same time, the controller 15 issues a pseudorange calculation order to the computing unit 14.

At step S106, upon receipt of the pseudorange calculation order from the controller 15, the computing unit 14 starts calculating a current position B of the GPS satellite 21 at a reception time tr of the signal at a measurement point (GPS position calculating apparatus 10) by using the orbital speed v acquired at step S105 and a time difference t obtained by subtracting the transmission time tb from the reception time tr as (t=tr−tb). The computing unit 14 further calculates a first angle α of the horizon e relative to a first line segment connecting the current position B of the GPS satellite 21 with a position O of the measurement position on the basis of a distance or range ct of the first line segment and the altitude h of the GPS satellite 21. In this instance, the first angle α is calculated using the equation: h=ct·sin α.

Subsequently, by using the calculated first angle α and the acquired orbital speed v of the GPS satellite 21, the computing unit 14 calculates a second angle β of the horizon relative to a second line segment connecting the reference position A of the GPS satellite 21 at the transmission time tb of the signal with the position O of the measurement point, on the basis of the foregoing angle relational expression (8).

Then, at step S107 the computing unit 14 calculates a distance or range cs of a second line segment connecting the reference position A of the GPS satellite 21 with the position O of the measurement point as a pseudorange on the basis of the first angle α and the range ct of the first line segment that are calculated at step S106 and the orbital speed v of the GPS satellite 21. In this instance, calculation of the pseudorange cs is performed by solving the foregoing equation (10). The computing unit 14 outputs the result of calculation (calculated pseudorange cs) to the controller 15.

Upon receipt of the pseudorange es from the computing unit 14, the controller 15 first stores the calculated pseudorange es in a predetermined storage area of the storage unit 16 at step S108 and then increments the count value i of the counter by one at step S109.

Subsequently, at step S110, the controller 15 compares the count value i of the counter with the number “n” of target GPS satellites. If the count value i is less the number “n” of target GPS satellites (i<n), the control process returns to step S102 (GPS signal reception judgment process) and, subsequently, those processing steps S102 to S109 which are already discussed above with respect to the signal from the target GPS satellite 21 will be repeated for each of the remaining target GPS satellites 22, 23.

When it is confirmed that the count value i has reached the number “n” of target GPS satellites (i=n) at step S110, the controller 15 issues a position calculation order to the computing unit 14.

At step S111, upon receipt of the position calculation order from the controller 15, the computing unit 14 performs calculation of a position of the measurement point on the basis of the acquired three-dimensional positions S (x, y, z) of the respective GPS satellites 21, 22, 23 and the calculated pseudoranges cs1, cs2, cs3 of the respective GPS satellites 21, 22, 23, and outputs the result of calculation (calculated position O of the measurement point) to the controller 15.

When achieving the calculation of a three-dimensional position O (x, y, z) of the measurement point on the basis of the respective positions S1, S2, S3 of the GPS satellites and the calculated pseudoranges cs1, cs2, cs3 of the GPS satellites, the computing unit 14 solves the following equation (12):

$$\{ \begin{matrix}cs 1 = \sqrt{{( x 1 - x )}^{2} + {( y 1 - y )}^{2} + {( z 1 - z )}^{2}} \\ cs 2 = \sqrt{{( x 2 - x )}^{2} + {( y 2 - y )}^{2} + {( z 2 - z )}^{2}} \\ cs 3 = \sqrt{{( x 3 - x )}^{2} + {( y 3 - y )}^{2} + {( z 3 - z )}^{2}}\end{matrix} \qquad ( 12 )$$

where cs1 is the range of the second line segment connecting the first position of the first GPS satellite with the position of the measurement point, cs2 is the range of the second line segment connecting the first position of the second GPS satellite with the position of the measurement point, cs3 is the range of the second line segment connecting the first position of the third GPS satellite with the position of the measurement point, (x,y,z) is the position coordinate of the receiver, (x1,y1,z1) is the position coordinate of the first GPS satellite, (x2,y2,z2) is the position coordinate of the second GPS satellite, and (x3,y3,z3) is the position coordinate of the third GPS satellite.

A solution to the equation (12) that is a system equation will give a three-dimensional position O (x, y, z) of the measurement point.

Finally, at step S112, the controller 15 delivers the calculated position of the measurement point and time to a piece of application software, such as routing assistance software for car navigation and terminates the afore-mentioned series of operations achieved to determine the position of the measurement point.

According to the GPS position calculating apparatus 10 according to the first embodiment of the present invention, information about an orbital speed v and transmission time tb, which is acquired from navigation data contained in signals transmitted from at least three GPS satellites 21, 22, 23, is used, and a position B of each of the GPS satellites at a reception time tr when the signal from each respective GPS satellite is received at the measurement point (i.e., the receiver 11) is calculated on the basis of the acquired orbital speed v and a time difference t obtained as (t=tr−tb). Subsequently, an angle α of the horizon relative to a first line segment connecting the calculated position B of each GPS satellite with a position O of the measurement point is calculated from a distance or range ct of the first segment and an altitude of each GPS satellite. Then, on the basis of the calculated range ct of the first line segment, the calculated first angle α, and the acquired orbital speed v, a distance or range cs of a second line segment connecting the position A of each GPS satellite with the position O of the measurement point is calculated.

The foregoing computation method or procedure of the present invention is relatively simple because it does not require the use of many GPS satellites and can eliminate the use of reference positioning data supplied from a base station on the earth. Calculation of the pseudorange cs requires data about an orbital speed v of each GPS satellite and an angle α, however, such pseudorange calculation can be achieved easily and accurately by merely replacing the pseudorange ct at the reception time of a GPS signal with the pseudorange cs at the transmission time of the same GPS signal.

Position calculation of a measurement point O(x, y, z), which is achieved on the basis of the GPS position A(x, y, z) at the signal transmission time and the calculated pseudorange cs, makes it possible to improve the position detecting accuracy at the measurement point.

In the flowchart shown in FIG. 4, step S105 corresponds to a navigation data acquiring section, which forms a part of the GPS position calculating apparatus 10 and which is configured to acquire orbit information from navigation data contained in the signals received at the receiver, wherein the navigation data includes a position A, clock time tb, orbital speed v and altitude h of each of the at least three GPS satellites at a transmission time when each GPS satellite transmits a respective one of the signals.

Step S106 corresponds to an elevation angle calculating section, which forms a part of the GPS position calculating apparatus 10 and which is configured to calculate a position B of each GPS satellite at the reception time tr of the signal at a measurement point by using the acquired orbital speed v and a time difference t obtained as (t=tr−tb) and to further calculate a first angle α of the horizon relative to a first line segment connecting the position B of each GPS satellite with a position O of the measurement point on the basis of a distance or range ct of the first line segment and the acquired altitude h.

Step S107 corresponds to a pseudorange calculating section, which forms a part of the GPS position calculating apparatus 10 and which is configured to calculate a range cs of a second line segment connecting the position A of each GPS satellite with the position O of the measurement point on the basis of the range ct of the first line segment, the first angle α calculated by the elevation angle calculating section, and the orbital speed v.

Step S111 corresponds to a position calculating section, which forms a part of the GPS position calculating apparatus 10 and which is configured to calculate the position O of the measurement point from the calculated ranges cs (cs1-cs3) of second line segments each connecting a respective one of the positions A (A1-A3 of the at least three GPS satellites with the position O of the measurement point.

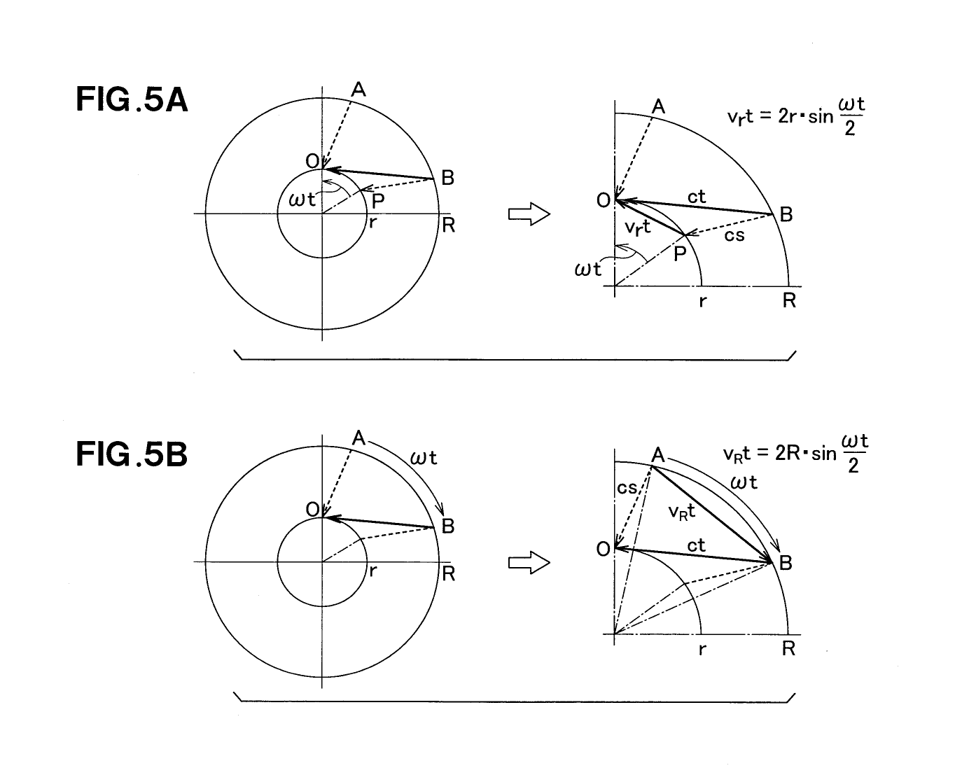

In the embodiment described above, two inertial coordinate systems are used to calculate the pseudoranges. However, because relative circular orbits can represent the relationship between each of the GPS satellites 21-23 and the measurement point on the earth, the inertial coordinate systems are actually rotational inertial coordinate systems. The relationship between the rotational movement in the rotational inertial coordinate systems and the signal transmission will be described with reference to FIGS. 5A and 5B.

FIG. 5A shows a relationship between the rotational movement and the signal transmission when viewed from the K-coordinate, and FIG. 5B shows a relationship between the rotational movement and the signal transmission when viewed from the Q-coordinate. As shown in FIG. 5A, when viewed from the K-coordinate, the GPS position calculating apparatus 10 located at the measurement point on the earth moves at time t from a position P to a position O by an angle ωt. On the other hand, as shown in FIG. 5B, when viewed from the Q-coordinate, the GPS satellite moves at time t from a position A to a position B by an angle ωt.

For the K-coordinate, the relationship between the movement and the time in the rotational movement can be calculated by the following expression (13). Similarly, for the Q-coordinate, the relationship between the movement and the time in the rotational movement can be calculated by the following expression (14):

$$vrt = 2 r sin \frac{ω t}{2} \qquad ( 13 )$$

where vrt is the speed of movement of the measurement point (GPS position calculating apparatus 10) on the earth at a point of time t, ω is the relative angular velocity between the measurement point and each GPS satellite, and r is the radius of the earth.

$$v Rt = 2 R sin \frac{ω t}{2} \qquad ( 14 )$$

where vRt is the speed of movement of each GPS satellite at t, w is the relative angular velocity between the measurement point and each GPS satellite, and R is the radius of the orbit of each GPS satellite.

Even for satellites having elliptic or more complicated orbits, the relationship between ct, cs and vrt does not change. It is therefore possible to calculate the pseudorange cs by drawing a triangular vector diagram having three vector components ct, cs, vrt. In a second embodiment where the movement-time relationship in a rotational movement, such as shown in FIGS. 5A and 5B, is taken into consideration, the GPS position calculating apparatus 10 is able to perform calculation of the pseudorange cs by achieving the same operation as done in the first embodiment excepting that the computing unit 14 calculates a relationship between the movement and the time in the rotational movement on the basis of the foregoing expressions (13) and (14).

As thus far described, the relationship between the GPS satellites 21-23 having circular orbits and the measurement point on the earth can be expressed by rotational inertial coordinate systems, and by calculating a relationship between the rotational movement and the time using the foregoing expressions (13) and (14), a pseudorange cs can be calculated accurately without involving any error even when the GPS satellites are moving in elliptic or more complicated orbits.

The GPS position calculating method according to the present invention is such a GPS position calculating method, which performs position detection of a measurement point (GPS point calculating apparatus 10) on the horizon e by receiving signals transmitted from at least three GPS satellites 21-23, as shown in FIG. 1.

The GPS position calculating method includes first to fourth steps as shown in FIG. 4, where the first step, as done at step S105, acquires orbit information from navigation data contained in the signals received at the receiver, wherein the orbit information includes position A, clock time tb, orbital speed v and altitude h of each of the GPS satellites at a transmission time when each GPS satellite transmits a respective one of the signals. Subsequently, the second step, as done at step S106, calculates a position B of each GPS satellite at a reception time when the signal from the GPS satellite is received at the measurement point, on the basis of the acquired orbit speed v and a time difference t obtained as (t=tr−b) and further calculates a first angle α of the horizon relative to a first line segment connecting the position B of each GPS satellite with a position O of the measurement point on the basis of a distance or range ct of the first line segment and the altitude h.

The third step, as done at step S107, calculates a distance or range of a second line segment connecting the position A of each GPS satellite with the position O of the measurement point on the basis of the range ct of the first line segment, the first angle α calculated at step S106, and the orbital speed v acquired at step S105. The fourth step, as done at step S111, calculates the position O of the measurement point from the ranges cs (cs1-cs3) of the second line segments each connecting a respective one of the position A (A1-A3) of the at least three GPS satellites with the position O of the measurement point that are calculated by the third step.

According to the GPS position calculating method of the present invention, it is possible to perform position detection of a measurement point with extremely high accuracy. For calculating the pseudorange cs, the GPS position calculating method of the present invention needs information about an orbit speed v and an angle α of each GPS satellite. However, merely by replacing the range ct, which has conventionally been used as a pseudorange, with the range cs, the calculation of the pseudorange cs can be achieved with high accuracy. Furthermore, in the case of a circular orbit, calculation of the pseudorange can be achieved accurately without involving any error.

The GPS position calculating method according to the present invention is such a calculation method, which can consider elevation-angle-dependent properties of the positioning error and, hence, is able to greatly improve the pseudorange calculation accuracy. The thus improved pseudorange calculation accuracy will offer a great improvement in the detecting accuracy of the position of the measurement point. Other advantageous effects attainable by the GPS position calculating method of the present invention in terms of the field of industrial application include simplification of the calculation method or procedure, and reduction in the number of GPS satellites used.

The GPS position calculating apparatus 10 of the configuration shown in FIG. 1 is also effectively operable when used as a GPS position calculating apparatus for calculating the position of the GPS satellites at signal transmission time. In this application, the measurement point in the first embodiment shown in FIGS. 2 and 4 constitutes a reference point on the horizon, which has a known position O. A typical example of such reference point is a fixed receiver station on the earth. In a second embodiment of the invention, where the GPS position calculating apparatus 10 is used as a GPS satellite position calculating apparatus, the computing unit 14 achieves a series of operations under program control by the controller 15, wherein the operations starts at a first step and ends at a forth step, as will be discussed below.

At the first step of operation, the computing unit 14 acquires orbit information of the GPS satellites 21, 22, 23 from navigation data contained in the signals received by the RF circuit 11b. The orbit information includes a position A1, A2, A3 (collectively designated as “A”), clock time tb1, tb2, b3 (collectively designated as “tb”), orbital speed v1, v2, v3 (collectively designated as “v”), and altitude h1, h2, h3 (collectively designated as “h”) of each of the GPS satellites 21, 22, 23 at a transmission time when each GPS satellite 21, 22, 23 transmits a respective signal.

At a second step of operation, the computing unit 14 calculates a position B1, B2, B3 (collectively designated as “B”) of each respective GPS satellites 21, 22, 23 at a reception time “tr” when the signal from each GPS satellite is received at the receiver 11 of the GPS position calculating apparatus 10 located at the reference point, from the acquired orbital speed v and a time difference “t” obtained by subtracting the transmission time tb from the reception time tr as (t=tr−tb). The computing unit 14 further calculates an angle α1, α2, α3 (collectively designated by “α”) which a line segment connecting the position B of each GPS satellite with a position O of the reference point forms with respect to the horizon.

At a third step of operation, the computing unit 14 calculates a distance cs1, cs2, cs3 (collectively designated as “cs”) from the position of the reference point to the position A of each GPS satellite 21, 22, 23 at the transmission time tb on the basis of a distance or range ct of the line segment and the angle α that are calculated at the second step and the altitude h acquired at the first step. The computing unit 14 thus calculates a pseudorange.

At a fourth step of operation, the computing unit 14 calculates the position of each respective GPS satellite at the transmission time from the distances cs between the position O of the reference point and the respective positions A of the at least three GPS satellites 21-23 that are calculated at the third step.

The first to fourth operation steps are programmed in advance and stored in the storage unit 16. The controller 15 constituted by, for example, a microprocessor sequentially retrieves and executes the program stored in the storage unit 16, urging the computing unit 14 to perform calculation of the angles α and distances cs (pseudoranges) and calculation of the position of each GPS satellite at the signal transmission time tb.

The storage unit 16 also stores other pieces of information concerning the center position and radius “r” of the earth, frequencies of the GPS satellites 21, 22, 23, and the speed “c” of light that are referenced by the controller 15.

As thus far described, operation to calculate the angle α, distance cs (pseudorange) and the position A of each GPS satellite at the signal transmission time tb is achieved by the computing unit 14 under the control of the control unit 15. However, the control unit 15 may undertake such calculating operation in place of the computing unit 14.

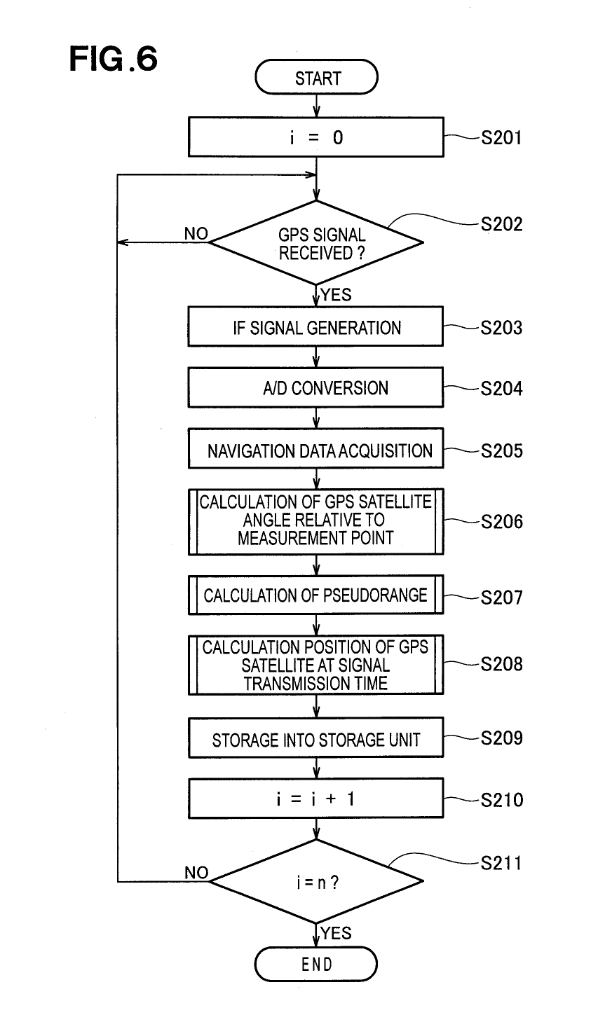

Operation of the GPS position calculating apparatus 10 used as GPS satellite position calculating apparatus according to the second embodiment of the present invention will be described in detail with reference to a flowchart shown in FIG. 6. The flowchart shows a sequence of operations to be executed by the controller 15.

At step S201, the controller 15 sets a count value i of a counter assigned to the program to “0”. The counter counts the number of target GPS satellites from which signals are to be received. In the illustrated embodiment, the number “n” of target GPS satellites is three, and these three target Satellites 21, 22 and 23 are used for detecting a position of the reference point.

At step S202, the controller 15 determines as to whether a high-frequency analog signal transmitted from the first GPS satellite 21 has been received by the RF circuit 11b. If an affirmative determination is made (YES) at step S202, the control process goes on to step S203, where the RF circuits 11b down-converts the high-frequency analog signal into an IF analog signal and outputs the IF analog signal to the A/D converter 12.

Subsequently, the controller 15 issues a signal conversion order to the A/D converter 12, whereupon at step S204, the A/D converter converts the IF analog signal to a digital signal and outputs the digital signal to the correlator 13 and the controller 15. Subsequently, at step S205 the controller 15 acquires navigation data (orbital speed v, transmission time tb, and altitude h) from the digital signal and outputs the acquired navigation data to the computing unit 14. At the same time, the controller 15 issues a pseudorange calculation order to the computing unit 14.

At step S206, upon receipt of the pseudorange calculation order from the controller 15, the computing unit 14 starts calculating a position B of the GPS satellite 21 at a reception time tr when the signal from the GPS satellite 21 is received at the receiver station (position O of the reference point) by using the orbital speed v acquired at step S205 and a time difference t obtained by subtracting the transmission time tb from the reception time tr as (t=tr−tb).

The computing unit 14 further calculates an angle α, which a line segment connecting the position B of the GPS satellite 21 with a position O of the reference point forms with respect to the horizon e. Subsequently, by using the calculated angle α and the acquired orbital speed v of the GPS satellite 21, the computing unit 14 calculates a angle β which a line segment connecting the position A of the GPS satellite 21 at the signal transmission time tb with the position O of the reference point forms with respect the horizon. Calculation of the angles α and β is done in accordance with the foregoing angle relational expression (8).

Then, at step S207 the computing unit 14 calculates a distance cs between the position A of the GPS satellite 21 and the position O of the reference point as a pseudorange on the basis of the angle α calculated at step S206, a distance ct between the position B of the GPS satellite 21 and the position O of the reference point which is already known, and the acquired altitude h of the GPS satellite 21. In this instance, the computing unit 14 solves the foregoing equation (10) to calculate the distance cs (pseudorange).

Subsequently, at step S208, the computing unit 14 calculates a position Ai (=Si (xi, yi, zi)) of the GPS satellite 21 at the signal transmission time tb by solving the foregoing equation (12) using the distance cs (pseudorange) between the position A of the GPS satellite 21 and the known position O of the reference point. The computing unit 14 outputs the result of calculation (calculated position Ai of the GPS satellite 21) to the controller 15.

Upon receipt of information about the position A of the GPS satellite 21 from the computing unit 14, the controller 15 first stores the received information in a predetermined storage area of the storage unit 16 at step S209 and then increments the count value i of the counter by one at step S210.

Subsequently, at step S211, the controller 15 compares the count value i of the counter with the number “n” of target GPS satellites. If the count value i is less the number “n” of target GPS satellites (i<n), a negative determination (“NO”) will be made at S211. Thus, the control process returns to step S202 (GPS signal reception judgment process) and, thereafter, those processing steps S202 to S210 which are already discussed above with respect to the signal from the target GPS satellite 21 will be repeated for each of the remaining target GPS satellites 22, 23. During that time, the computing unit 14 calculates the distance cs between the position A of each GPS satellite at the signal transmission time tb and the known position O of the reference point to thereby get a pseudorange for each respective GPS satellite, and calculates from the pseudoranges of the GPS satellites 21-23, positions A of the respective GPS satellites 21, 22, 23 at the signal transmission time tb by solving the foregoing equation (12), where the position of each respective GPS satellites 21-23 is represented by components of three-dimensional coordinate, such as S1 (x1, y1, z1), S2 (x2, y2, z2) and S3 (x3, y3, z3).

When it is confirmed that the count value i has reached the number “n” of target GPS satellites (i=n) at step S211, this means that an affirmative determination (“YES”) is made at S211 and the controller 15 will terminate the afore-mentioned series of operations that have been performed to calculate the GPS satellite positions A.

According to the second embodiment of the GPS position calculating apparatus as used in a GPS satellite position calculating apparatus, the distance between the position A of each GPS satellite at the signal transmission time and the known position O of the reference point is used as a pseudorange in the process of calculating the position of the GPS satellite. Unlike the conventional arrangement in which the distance between the position B of each GPS satellite at the signal reception time and the known position O of the reference point is used as a pseudorange in the process of calculating the position A of the GPS satellite, the aforesaid arrangement of the present invention is able to simplify the calculation method or procedure, increase the calculation accuracy, and eventually improve the accuracy in detecting the position of GPS satellite. Calculation of the pseudorange requires data about the orbit speed v and angle α of the GPS satellite, but merely by replacing the pseudorange ct the GPS satellite at the signal reception time with the pseudorange cs at the signal transmission time, the pseudorange calculation can be achieved simply with increased accuracy.

In the flowchart shown in FIG. 6, step S205 corresponds to a navigation data acquiring section, which forms a part of the GPS satellite position calculating apparatus and which is configured to acquire orbit information from the signals, the orbit information including signal transmission time tb, orbital speed v and altitude h of each of the at least three GPS satellite.

Step S206 corresponds to an elevation angle calculating section, which forms a part of the GPS satellite position calculating apparatus and which is configured to calculate a position B of each respective GPS satellite at reception time tr, by using the acquired orbital speed v and a time difference t obtained by subtracting the transmission time tb from the reception time tr as (t=tr−tb) and to further calculate a angle α which a line segment connecting the position B of each GPS satellite with a position O of the reference point forms with respect to the horizon.

Step S207 corresponds to a pseudorange calculating section, which forms a part of the GPS satellite position calculating apparatus and which is configured to calculate a range cs from the position O of the reference point to a position A of each GPS satellite at the transmission time tb on the basis of the range ct from the position O of the reference point to the position B of each GPS satellite, the altitude h and the angle α.

Step S208 corresponds to a satellite position calculating section, which forms a part of the GPS satellite position calculating apparatus and which is configured to calculate the position A of each respective GPS satellite at transmission time, from the calculated distance cs between the position O of the reference point and the position A of each of the at least three GPS satellites 21-23.

Description will next be made about a third embodiment of the present invention in which the distance ct between the GPS satellite position at signal reception time tr and the portion O of the reference point is used as a pseudorange in the process of calculating the position of the GPS satellite. In the third embodiment, the GPS position calculating apparatus 10 of the configuration shown in FIG. 1 is used as a GPS satellite position calculating apparatus with the exception that the computing unit 14 is configured to achieve a series of operations under program control by the controller 15, wherein the operations starts at a first step and ends at a forth step, as will be discussed below.

At the first step of operation, the computing unit 14 acquires orbit information of the GPS satellites 21, 22, 23 from navigation data contained in the signals received by the RF circuit 11b. The orbit information includes a position A1, A2, A3 (collectively designated as “A”), clock time tb1, tb2, b3 (collectively designated as “tb”), orbital speed v1, v2, v3 (collectively designated as “v”), and altitude h1, h2, h3 (collectively designated as “h”) of each of the GPS satellites 21, 22, 23 at a transmission time when each GPS satellite 21, 22, 23 transmits a respective signal.

At a second step of operation, the computing unit 14 calculates a position B1, B2, B3 (collectively designated as “B”) of each respective GPS satellites 21, 22, 23 at a reception time “tr” when the signal from each GPS satellite is received at the receiver 11 of the GPS position calculating apparatus 10 located at the reference point, from the acquired orbital speed v and a time difference “t” obtained by subtracting the transmission time tb from the reception time tr as (t=tr−tb).

At a third step of operation, the computing unit 14 calculates a distance ct1, ct2, ct3 (collectively designated as “ct”) between the position O of the reference point and the GPS satellite position B at reception time tr (obtained at the second step) as a pseudorange.

At a fourth step of operation, the computing unit 14 calculates the position of each respective GPS satellite at the transmission time from the distance ct between the position O of the reference point and the position at the GPS satellite position B at the reception time tr that has been calculated at the third step with respect to each of the at least three GPS satellites 21-23.

The first to fourth operation steps are programmed in advance and stored in the storage unit 16. The controller 15 constituted by, for example, a microprocessor sequentially retrieves and executes the program stored in the storage unit 16, urging the computing unit 14 to perform calculation of the position of the GPS satellites on the basis of the distance ct (pseudorange).

The storage unit 16 also stores other pieces of information concerning the center position and radius “r” of the earth, frequencies of the GPS satellites 21, 22, 23, and the speed “c” of light that are referenced by the controller 15.

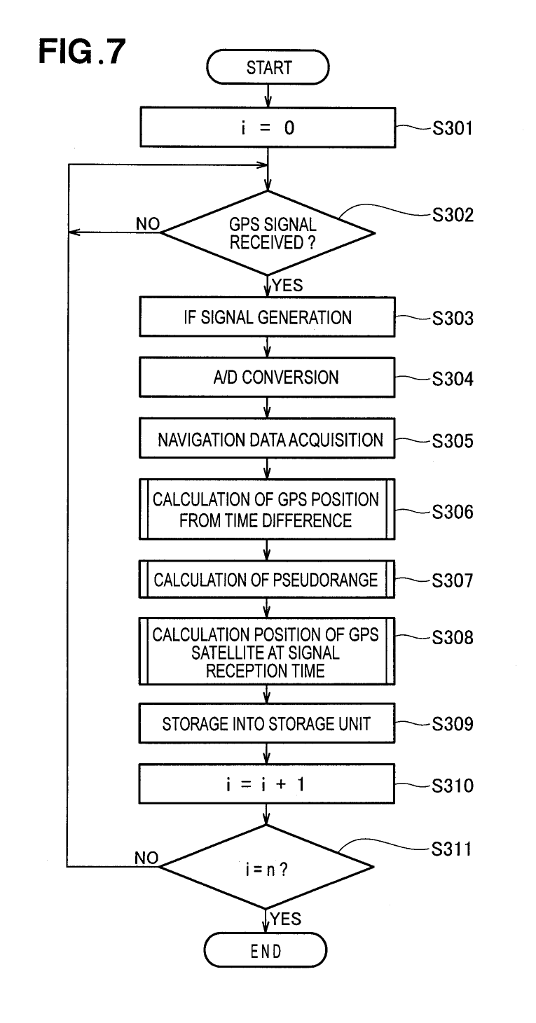

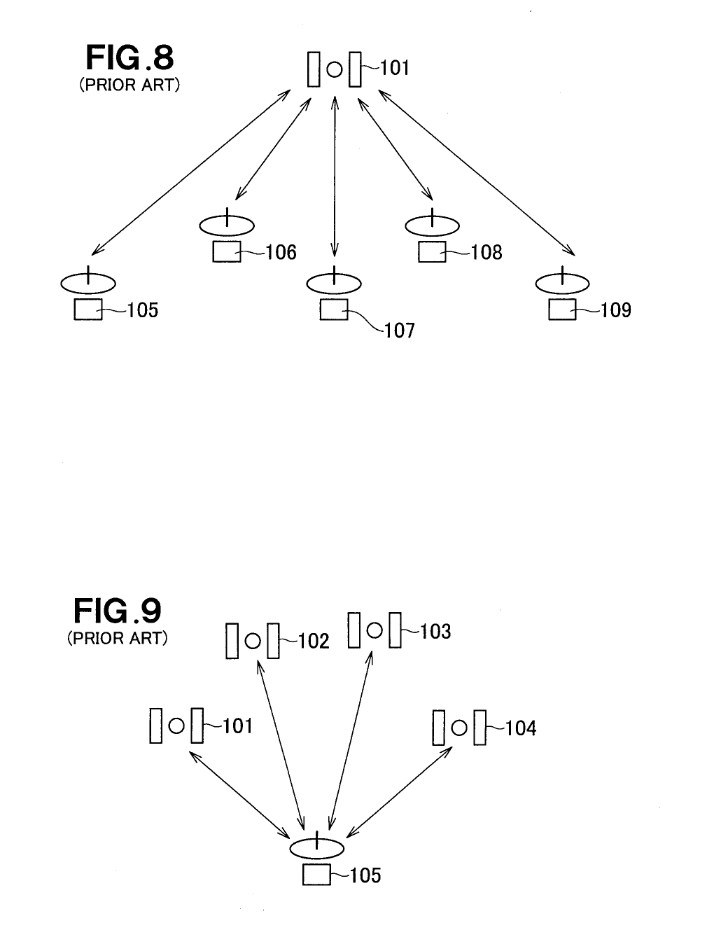

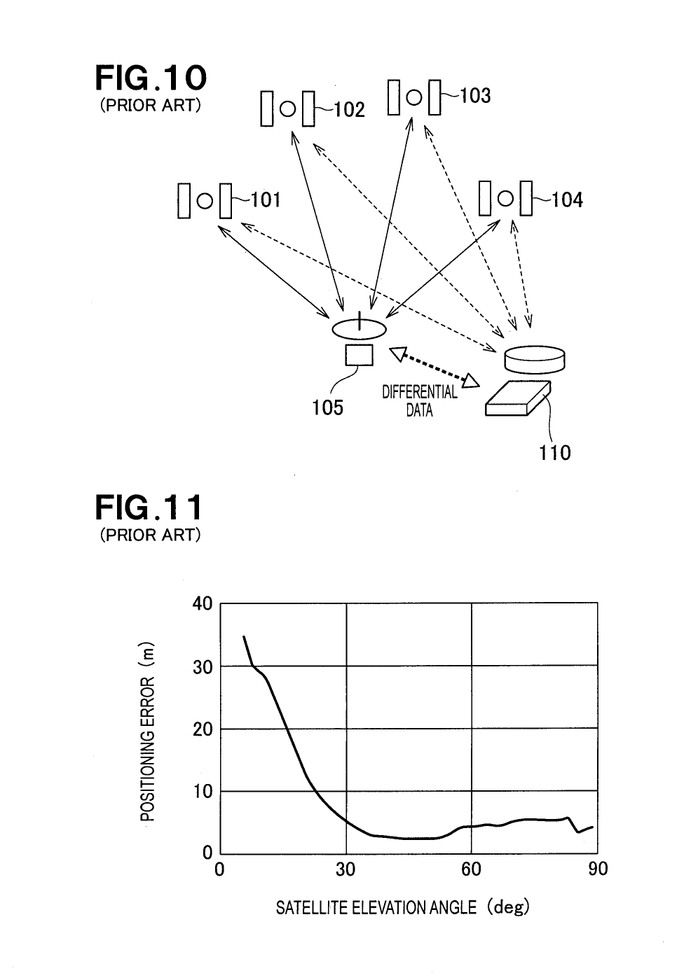

Operation of the GPS position calculating apparatus 10 used as GPS satellite position calculating apparatus according to the third embodiment of the present invention will be described in detail with reference to a flowchart shown in FIG. 7 while focusing on differences from the second embodiment. These operations, which are achieved by consecutive steps S301 to S304 are the same as those achieved by steps S201 to S204 in the second embodiment, and description will begins at step S305 where navigation data is acquired.

At step S305, the controller 15 acquires navigation data (orbital speed v, transmission time tb, and altitude h) from the digital signal and outputs the acquired navigation data to the computing unit 14. At the same time, the controller 15 issues a pseudorange calculation order to the computing unit 14.

At step S306, upon receipt of the pseudorange calculation order from the controller 15, the computing unit 14 starts calculating a position B of the GPS satellite 21 at a reception time tr when the signal from the GPS satellite 21 is received at the receiver station (position O of the reference point) by using the orbital speed v acquired at step S305 and a time difference t obtained by subtracting the transmission time tb from the reception time tr as (t=tr−tb). Subsequently at step S307, the time difference (t=tr−tb) is multiplied by the speed of light so that the distance ct between the GPS satellite and the reference point at the reception time tr of the signal at the reference point is calculated as a pseudorange.

Subsequently, at step S308, the computing unit 14 calculates a position Bi (=Si (xi,yi,zi)) of the GPS satellite 21 at the signal transmission time tb by solving the foregoing equation (12) using the distance ct (pseudorange) between the position B of the GPS satellite 21 and the known position O of the reference point. The computing unit 14 outputs the result of calculation (calculated position B of the GPS satellite 21) to the controller 15.

Upon receipt of information about the position B of the GPS satellite 21 from the computing unit 14, the controller 15 first stores the received information in a predetermined storage area of the storage unit 16 at step S309 and then increments the count value i of the counter by one at step S310.

Subsequently, at step S311, the controller 15 compares the count value i of the counter with the number “n” of target GPS satellites. If the count value i is less the number “n” of target GPS satellites (i<n), a negative determination (“NO”) will be made at S311. Thus, the control process returns to step S302 (GPS signal reception judgment process) and, thereafter, those processing steps S302 to S310 which are already discussed above with respect to the signal from the target GPS satellite 21 will be repeated for each of the remaining target GPS satellites 22, 23. During that time, the computing unit 14 calculates the distance ct between the position B of each GPS satellite at the signal reception time tb and the known position O of the reference point to thereby get a pseudorange for each respective GPS satellite, and calculates from the pseudoranges of the GPS satellites 21-23, positions B of the respective GPS satellites 21, 22, 23 at the signal reception time tr by solving the foregoing equation (12), where the position of each respective GPS satellites 21-23 is represented by components of three-dimensional coordinate, such as S1 (x1, y1, z1), S2 (x2, y2, z2) and S3 (x3, y3, z3).

When it is confirmed that the count value i has reached the number “n” of target GPS satellites (i=n) at step S311, this means that an affirmative determination (“YES”) is made at S311 and the controller 15 will terminate the afore-mentioned series of operations that have been performed to calculate the GPS satellite positions B.

According to the third embodiment of the GPS position calculating apparatus as used in a GPS satellite position calculating apparatus, the distance between the position B of each GPS satellite at the signal transmission time and the known position O of the reference point is used as a pseudorange in the process of calculating the position B of the GPS satellite. Unlike the conventional arrangement in which the distance between the position A of each GPS satellite at the signal transmission time and the known position O of the reference point is used as a pseudorange in the process of calculating the position of the GPS satellite, the aforesaid arrangement of the present invention is able to simplify the calculation method or procedure, increase the calculation accuracy, and eventually improve the accuracy in detecting the position of GPS satellite. Furthermore, calculation of the GPS satellite position at the signal reception time does not require observation data to be supplied from a known receiver site on the earth and this arrangement adds to the degree of simplification of the calculation method of procedure.

Although in the third embodiment of the present invention just described above with reference to FIG. 7, the distance ct between the calculated position B of each GPS satellite and the known position O of the reference position is treated as a pseudorange, it is also possible according to the present invention to calculate from the position O of the reference point, a distance or range cs of a line segment connecting the position A of each GPS satellite with the position O of the reference point and use the calculated range cs of the line segment as a pseudorange. In this case, calculation quantity increases. However, because calculation of the pseudorange is possible without using elevation angle, this allows for the use of an existing GPS positioning system, leading to a reduction in calculation load.

In the flowchart shown in FIG. 7, step S305 corresponds to a navigation data acquiring section, which forms a part of the GPS satellite position calculating apparatus and which is configured to acquire orbit information from the signals, the orbit information including signal transmission time tb, orbital speed v and altitude h of each GPS satellite.

Steps S306 and S307 together correspond to a pseudorange calculating section, which forms a part of the GPS satellite position calculating apparatus and which is configured to calculate the position B of each GPS satellite at signal reception time tr from a time difference between the reception time tr and the transmission time tb and the acquired orbital speed v and further calculate the distance ct from the position O of the reference point to the position B of the GPS satellite at signal reception time tr.

Step S308 corresponds to a satellite position calculating section, which forms a part of the GPS satellite position calculating apparatus and which is configured to calculate the position B of each respective GPS satellite at reception time tr, from the calculated distance ct between the position O of the reference point and the position B of each of the at least three GPS satellites 21-23.

The GPS position calculating apparatus (including a GPS satellite position calculating apparatus) according to the present invention can be used not only in a car navigation system but also in the field of position detection of a measurement point, which is formed by a movable object, such as a marine vessel, aircraft, working vehicle, or mobile terminal. When used in combination with a method of estimating pseudorange error with reference to differential data, the GPS position calculating apparatus of the present invention is able to further improve the position detecting accuracy. The GPS position calculating apparatus of the present invention is also able to calculate an atmosphere delay and an ionosphere with high accuracy, which will greatly increase the weather observation accuracy.

Obviously, various minor changes and modifications of the present invention are possible in the light of teaching. It is to be noted that within the scope of the appended claims the invention may be practiced otherwise than as specifically described.

What is claimed is:

1. A position calculating method using a global positioning system (GPS) for determining the position of a measurement point on the horizon by a computing unit on the basis of signals received at a receiver on the measurement point from at least three GPS satellites, the method comprising:
a first step of acquiring orbit information from navigation data contained in the signals received at the receiver, said orbit information including a first position, clock time, orbital speed and altitude of each of the GPS satellites at a time when each GPS satellite transmits a respective one of the signal;
a second step of calculating a second position of each GPS satellite at a time when the signal from each GPS satellite is received at the receiver, by using the acquired orbital speed and a time difference obtained by subtracting the signal transmission time from the signal reception time, and further calculating a first angle of the horizon relative to a first line segment connecting the second position of each GPS satellite with a position of the measurement point on the basis of a range of the first line segment and the acquired altitude;
a third step of calculating a range of a second line segment connecting the first position of each GPS satellite with the position of the measurement point on the basis of the range of the first line segment, the first angle, and the orbital speed; and
a fourth step of calculating the position of the measurement point from the respective ranges of the second line segments each connecting a respective one of the first positions of the at least three GPS satellites with the position of the measurement point.

2. The position calculating method according to claim 1, wherein said second step further calculates a second angle of the horizon relative to the second line segment connecting the first position of each GPS satellite with the position of the measurement point on the basis of the calculated first angle and the acquired orbital speed of each respective GPS satellite.

3. The position calculating method according to claim 2, wherein said second step achieves calculation of the first angle or the second angle by solving the following equation (101):
$${sin}^{2} α = \{ {( cos \partial - \frac{v}{c} )}^{2} + {sin}^{2} α \} {sin}^{2} β \qquad ( 101 )$$
where α is the first angle, β is the second angle, v is the acquired orbital speed of each GPS satellite, and c is the speed of light.

4. The position calculating method according to claim 1, wherein said third step achieves calculation of the range of the second line segment by solving the following equation (102):
$$cs = \sqrt{{( cos α - \frac{v}{c} )}^{2} + {sin}^{2} α} \times ct \qquad ( 102 )$$
where cs is the range of the second line segment, α is the first angle, v is the orbital speed of each GPS satellite, c is the speed of light, and ct is the range of the first line segment.

5. The position calculating method according to claim 1, wherein said third step achieves calculation of the range of the second line segment by further calculating speeds of movement of the measurement point and each GPS satellite in rotational inertial coordinate systems using the following expressions (103) and (104):
$$vrt = 2 r sin \frac{ω t}{2} \qquad ( 103 )$$
where vrt is the speed of movement of the measurement point on the earth at a point of time t, ω is the relative angular velocity between the measurement point and each GPS satellite, and r is the radius of the earth.
$$v R t = 2 R sin \frac{ω t}{2} \qquad ( 104 )$$
where vRt is the speed of movement of each GPS satellite at t, ω is the relative angular velocity between the measurement point and each GPS satellite, and R is the radius of the orbit of each GPS satellite.

6. The position calculating method according to claim 1, wherein said fourth step achieves calculation of the position of the measurement point by solving the following equation (105):
$$\{ \begin{matrix}cs 1 = \sqrt{{( x 1 - x )}^{2} + {( y 1 - y )}^{2} + {( z 1 - z )}^{2}} \\ cs 2 = \sqrt{{( x 2 - x )}^{2} + {( y 2 - y )}^{2} + {( z 2 - z )}^{2}} \\ cs 3 = \sqrt{{( x 3 - x )}^{2} + {( y 3 - y )}^{2} + {( z 3 - z )}^{2}}\end{matrix} \qquad ( 105 )$$
where cs1 is the range of the second line segment connecting the first position of the first GPS satellite with the position of the measurement point, cs2 is the range of the second line segment connecting the first position of the second GPS satellite with the position of the measurement point, cs3 is the range of the second line segment connecting the first position of the third GPS satellite with the position of the measurement point, (x,y,z) is the position coordinate of the receiver, (x1,y1,z1) is the position coordinate of the first GPS satellite, (x2,y2,z2) is the position coordinate of the second GPS satellite, and (x3,y3,z3) is the position coordinate of the third GPS satellite.

7. A position calculating apparatus using a global positioning system (GPS) for determining the position of a measurement point on the horizon by a position calculating unit on the basis of signals received at a receiver on the measurement point from at least three GPS satellites, said apparatus comprising:
a navigation data acquiring section for acquiring orbit information from navigation data contained in the signals received at the receiver, said orbit information including a first position, clock time, orbital speed and altitude of each of the GPS satellites at a time when each GPS satellite transmits a respective one of the signals;
an elevation angle calculating section for calculating a second position of each respective GPS satellite at a time when the signal from each respective GPS satellite is received at the receiver, by using the acquired orbital speed and a time difference obtained by subtracting the signal transmission time from the signal reception time, and further calculating a first angle of the horizon relative to a first line segment connecting the second position of each GPS satellite with a position of the measurement point on the basis of a range of the first line segment and the acquired altitude;
a pseudorange calculating section for calculating a range of a second line segment connecting the first position of each GPS satellite with the position of the measurement point on the basis of the calculated range of the first line segment, the first angle, and the orbital speed; and
a position calculating section for calculating the position of the measurement point from the respective ranges of the second line segments each connecting a respective one of the first positions of the at least three GPS satellites with the position of the measurement point.

8. A GPS (global positioning system) satellite position calculating method wherein signals transmitted from at least three GPS satellites are received by a receiver at a reference point on the horizon, and the position of each respective GPS satellite at a transmission time when each GPS satellite transmits a respective one of the signals is calculated by a computing unit on the basis of a known position of the reference point, the method comprising:
a first step of acquiring orbit information from the signals received at the receiver from the GPS satellites, the orbit information including a transmission time of each of the signals, orbital speed and altitude of each GPS satellite;
a second step of calculating a position of each of the GPS satellites at a reception time when the signal from each GPS satellite is received at the receiver, from the acquired orbital speed and a time difference between the reception time and the transmission time, and further calculating an angle which a line segment connecting the position of the GPS satellite at the reception time with the position of the reference point forms with respect to the horizon;
a third step of calculating a distance from the position of the reference point to the position of each GPS satellite at the transmission time on the basis of a distance from the position of the reference point to the position of each respective GPS satellite at the reception time, the acquired altitude, and the angle; and
a fourth step of calculating the position of each respective GPS satellite at the transmission time from the calculated distance from the position of the reference point to the position of each of the at least three GPS satellite at the transmission time.

9. A GPS (global positioning system) satellite position calculating apparatus including a receiver for receiving signals transmitted from at least three GPS satellites, and a computing unit for calculating the position of each of the GPS satellites at a transmission time when each GPS satellite transmits a respective signal on the basis of a reference position having a known position on the horizon, the apparatus comprising:
a navigation information acquiring section for acquiring orbit information from the signals received at the receiver from the GPS satellites, the orbit information including a transmission time of each respective signal, orbital speed and altitude of each GPS satellite;
an elevation angle calculating section for calculating a position of each respective GPS satellite at a reception time when the signal from each GPS satellite is received at the receiver, by using the acquired orbital speed and a time difference between the reception time and the transmission time, and further calculating an angle which a line segment connecting the position of the GPS satellite at the reception time with the position of the reference point forms with respect to the horizon;
a pseudorange calculating section for calculating a distance from the position of the reference point to the position of each GPS satellite at the transmission time on the basis of a distance from the position of the reference point to the position of each respective GPS satellite at the reception time, the acquired altitude, and the angle; and
a satellite position calculating section for calculating the position of each respective GPS satellite at the transmission time from the calculated distance from the position of the reference point to the position of each of the at least three GPS satellite at the transmission time.
